(19) United States
(12) Patent Application Publication
(10) Pub. No.: US 2024/0375585 A1
(43) Pub. Date: Nov. 14, 2024

(54) Tractor Trailer Sensing System

(71) Applicants: Frederick M. Moore, Watertown, MA (US); Yibiao Zhao, Boston, MA (US); Ripudaman Singh Arora, Medford, MA (US); Hung-Jui Huang, Pittsburgh, PA (US)

(72) Inventors: Frederick M. Moore, Watertown, MA (US); Yibiao Zhao, Boston, MA (US); Ripudaman Singh Arora, Medford, MA (US); Hung-Jui Huang, Pittsburgh, PA (US)

(21) Appl. No.: 18/196,758

(22) Filed: May 12, 2023

(51) Int. Cl. B60R 1/00; B60R 11/04; G06V 20/56

(52) U.S. Cl. CPC B60R 1/003; B60R 11/04; G06V 20/56; B60R 2300/402; B60R 2300/808

(57) ABSTRACT

A system for imaging at least one of a trailer or other conveyance that is connected to a tractor and an environment proximate the tractor, wherein the trailer or other conveyance has two opposed lateral sides, the system comprising a plurality of sensors mounted to the tractor, wherein the sensors together have an active sensing area that encompasses at least the two opposed lateral sides of the trailer or other conveyance.

### CROSS-REFERENCE TO RELATED APPLICATION

This application claims priority to PCT/US2021/059547 filed Nov. 16, 2021 which claims priority to U.S. Provisional Application 63/114,237 filed on Nov. 16, 2020, the disclosures of which are incorporated herein for all purposes.

### BACKGROUND

This disclosure relates to the navigation of a tractor-trailer combination.

Trailers and other wheeled conveyances are coupled to tractors and then autonomously moved through locations such as cargo yards, warehouse facilities, and intermodal facilities. Navigation and object avoidance need to be carried out in real time.

### SUMMARY

In an aspect, a system for imaging at least one of a trailer or other conveyance that is connected to a tractor and an environment proximate the tractor, wherein the trailer or other conveyance has two opposed lateral sides (the left and right sides), includes a plurality of sensors mounted to the tractor. The sensors together have an active sensing area that encompasses at least the two opposed lateral sides of the trailer or other conveyance.

Some examples include one of the above and/or below features, or any combination thereof. In an example the trailer or other conveyance has a width between the two opposed lateral sides and the plurality of sensors comprises a left sensor mounted to a left side of the tractor and a right sensor mounted to a right side of the tractor, wherein the left and right sensors are spaced apart by a distance that is greater than the width of the trailer or other conveyance. In some examples the tractor has a left side and a right side, and the plurality of sensors comprises a left sensor mounted such that it extends outwardly away from the left side of the tractor and a right sensor mounted such that it extends outwardly away from the right side of the tractor. In an example the left and right sensors are spaced apart by more than 102 inches. In an example the tractor has a front, a rear, and a top, and the plurality of sensors further comprises at least one of a front sensor mounted to the front of the tractor, a rear sensor mounted to the rear of the tractor, and a top sensor mounted to the top of the tractor. In an example the left and right sensors are spaced apart sufficiently such that they can obtain sufficient data along the entire side of the trailer or other conveyance when misalignment between the tractor and the trailer or other conveyance is about 3 degrees.

Some examples include one of the above and/or below features, or any combination thereof. In some examples the plurality of sensors comprises at least one distance ranging sensor. In an example the at least one distance ranging sensor comprises at least one of a LIDAR-based sensor, a radar-based sensor, and an ultrasonic-based sensor. In an example the left and right sensors are distance ranging sensors. In an example the trailer or other conveyance has a bottom height, and the left and right sensors are mounted below the bottom height of the trailer or other conveyance. In some examples the left and right distance ranging sensors are spaced apart laterally such that a resolution on a determination of a length of the trailer or other conveyance, and a maximum allowable spacing of the data points returned from left and right sides of the trailer or other conveyance, is in the range of from about 1 cm to about 50 cm.

Some examples include one of the above and/or below features, or any combination thereof. In some examples the system further includes a processor that is configured to process data from the plurality of sensors to develop position data for the trailer or other conveyance. In an example the processor is further configured to fit a predetermined shape representing the trailer or other conveyance to the position data. In an example the position data for the trailer or other conveyance comprises at least one of a trailer or other conveyance length, a trailer or other conveyance width, a trailer or other conveyance height, a location of a rear axle of the trailer or other conveyance, a location of a kingpin, and an angle between the tractor and the trailer or other conveyance. In an example the left and right sensors are spaced apart sufficiently such that they can obtain position data along the entire sides of the trailer or other conveyance when misalignment between the tractor and the trailer or other conveyance is up to about 3 degrees. In an example the left and right sensors are displaced laterally away from the tractor a sufficient distance such that the portion of the sensor field of view (FoV) filled by the trailer or other conveyance side wall is at least about 0.3 degrees, when the tractor and the trailer or other conveyance are misaligned by up to about +/−3.0 degrees.

Some examples include one of the above and/or below features, or any combination thereof. In an example the tractor has a left side, a right side, a front, a rear, and a top, and the plurality of sensors comprise at least one of a front camera mounted proximate the front of the tractor, a rear camera mounted proximate the rear of the tractor, a right side camera mounted proximate the right side of the tractor and configured to image at least the right side of the trailer or other conveyance, a left side camera mounted proximate the left side of the tractor and configured to image at least the left side of the trailer or other conveyance, and a top camera mounted proximate the top of the tractor and configured to image at least the front of the trailer or other conveyance. In an example at least one camera is oriented with a field of view proximate (e.g., away from) a side of the tractor, and the system further comprises an illumination system configured to provide light to the at least one camera field of view. In an example the trailer or other conveyance has a front side, and a camera is oriented with a field of view that includes the front side of the trailer or other conveyance. In an example the at least one camera is configured to be used for at least one of: static object detection, dynamic object detection, lane marking, safety identification, dock door identification, trailer or other conveyance identification, inspection for damage to the trailer or other conveyance, and robotic connection of the air hoses and electrical connections of the tractor to the trailer or other conveyance.

Some examples include one of the above and/or below features, or any combination thereof. In some examples the system further comprises a global positioning system (GPS) carried at least in part by the tractor. In an example the GPS comprises two GPS antennas mounted to a roof of the tractor, such that a position and attitude of the tractor can be determined using the two GPS antennas without the need for the tractor to be in motion. In an example the GPS comprises a third antenna located externally of the tractor in a fixed, non-moving location, and serving as a reference point for the GPS.

In another aspect a method for calibrating sensors for a system for spatially imaging at least one of a trailer or other conveyance that is connectable to a tractor when the trailer or other conveyance is connected to the tractor and an environment proximate the tractor includes identifying an axis of rotation between the tractor and the connectable trailer or other conveyance when the trailer or other conveyance is connected to the tractor, mounting a calibration sensor to the tractor when the connectable trailer or other conveyance is not connected to the tractor at an intersection point between the axis of rotation and the tractor, obtaining spatial data of objects displaced about the tractor with the calibration sensor and with one or more sensors of the spatial imaging system that are mounted to the tractor, and processing the spatial data to calibrate the one or more sensors of the spatial imaging system relative to the mounting location of the calibration sensor.

### BRIEF DESCRIPTION OF THE DRAWINGS

FIG. 1A is a top view of a tractor-trailer combination and FIG. 1B is a side view thereof.

FIG. 1C is a schematic representation of a tractor chassis.

FIG. 2 is a schematic block diagram of a tractor-trailer imaging and navigation system.

FIG. 3 is a model of a tractor-trailer combination useful in understanding aspects of the present disclosure.

FIG. 4 is a flowchart of a trailer state estimation method.

FIG. 5 is a top view of a tractor maneuvering to pick up a trailer.

FIG. 6 is a top view of a tractor-trailer maneuvering to drop off the trailer.

### DETAILED DESCRIPTION

In the present tractor trailer sensing system, sensors are coupled to the tractor. The sensors can be used for distance ranging and/or imaging. In some examples the distance ranging sensors include one or more of LiDAR, radar and ultrasonic-based sensors. In some examples the imaging sensors include optical imaging sensors such as cameras. Lights may be provided to light the field of view (FoV) of any one or more of the cameras. In some examples radar with Doppler effect can be used to detect motion of the tractor, the trailer, or their combination. For example motion of trailer wheels can be detected. This may be used as an indication that the trailer is in motion.

In some examples the sensors are used to determine the angle between the tractor and the trailer. In some examples the sensors are used to determine the dimensions of the trailer. In some examples the sensing system is used to assist with one or more of navigation of the tractor-trailer, detection of objects, avoidance of objects, the identification of the trailer connected to the tractor, and/or the identification of other nearby trailers. In some examples one or more optical sensors mounted on the tractor can be configured to image the bottom of the trailer. In an example this imaging can be used to estimate the angle of the trailer relative to the tractor and/or the relative motion between the tractor and the trailer. In an example the imaging field of view can include the trailer kingpin; the kingpin image can be used to assist with necessary alignment of the tractor and trailer during the trailer capture or docking operation.

The subject sensing system can be used as part of an autonomous vehicle control system. Trailers and other wheeled conveyances (such as a chassis used to carry a shipping container) are commonly coupled to tractors using a “fifth wheel” coupling system that allows the trailer/conveyance to pivot relative to the tractor about a vertical kingpin axis. In order to properly navigate the tractor-trailer/conveyance, the navigation system needs to have real-time information regarding the angle between the trailer/conveyance and the tractor, as well as the location and heading of the tractor. Such real-time information can be based on data gathered by the sensor system.

In some examples the sensor system includes a number of sensors that are coupled to the tractor. The sensors include a plurality of distance ranging sensors and a plurality of optical imaging sensors. In some examples the distance ranging sensors are LiDAR sensors. LiDAR sensors are known in the field. They return a set of data points that represent the position of objects from which the laser light is reflected in the viewed area that is scanned by the energy source. In some examples the optical imaging sensors are digital cameras that return digital images of their field of view (FoV).

In an example the sensor system includes sensors mounted on the left and right sides of the tractor. In some examples the mounting is as rigid as possible, which can be accomplished by mounting the sensors (either directly or indirectly) to the unsprung chassis of the tractor rather than the sprung cab portion of the tractor. It should be understood that sprung and unsprung as the terms are used here refer to the relationship of the cab to the chassis, where the cab is sprung relative to the chassis. An advantage of mounting distance ranging sensors such as LiDAR on the chassis is it is independent of the cab movement (mainly pitch) with respect to the chassis. A disadvantage can be that there might be some shock, but this can be addressed with additional shock absorption mechanisms. In some examples a vibration isolation mount can be used to mount the LiDAR sensors to the unsprung chassis. In some examples such vibration isolation mounts are passive, which would include at least a spring and a damper coupling the LiDAR to the chassis, or to a mounting plate to which the LiDAR is rigidly fixed. In other examples the vibration isolation mounts are active, where an actuator is coupled between the LiDAR (or mounting plate) and the chassis, sensors for measuring vibration of the LiDAR and possibly the frame of the chassis at the location the active isolation mount is coupled to the frame, and an active controller to cancel vibration of the mounting plate. Such active vibration isolation mounts are well known in technical field.

In some examples sensor mounting can be standardized by mounting the sensors on a cab-protective frame that is a common add-on to yard trucks operating around a crane in a port use case. The frame is a rigid steel structure that is rigidly mounted to the chassis and located just behind the cab, with vertical frame members near the left and right rear corners of the cab, and a horizontal frame member connecting the vertical members and located just above the height of the cab. This frame is in some cases required for protection of drivers in the cab. By mounting sensors to the frame which is rigidly coupled to the chassis, the sensors are effectively mounted to the unsprung chassis which is independent of cab movement. Vibration isolation mounts coupling the sensors to the frame can also be used.

The left and right sensors are located such that their viewed area/FoV includes the left or right side of the trailer, respectively. In some examples the left and right sensors are spaced apart farther than the width of the trailer, so that the two lateral sides of the trailer are within the viewed area/FoV of the two sensors. In some examples the fields of view of the left and right sensors encompass the locations of open trailer rear doors; this allows the system to detect when the rear doors are open when they should not be. Many trailers and other towed structures such as containers carried by a chassis are mandated to be no more than 8.5 feet wide, although other widths are used. When these sensors are LiDAR sensors, each sensor returns a set of data points multiple times per second. These data points will include the position of the left and right side of the trailer. Since most trailers are essentially rectangular prisms or cuboids, their projection in a two-dimensional plane is a rectangle. The joint angle of the trailer can be determined by continuously fitting a rectangle (or three contiguous sides of a rectangle) of the size of the trailer to the data in the plane returned by the distance ranging sensors. When the front, left, and right sides of a trailer, container, chassis, or other conveyance being pulled by the tractor are sensed (and the rear side is not), the fitted shape may comprise three contiguous sides of a rectangle rather than all four sides.

In some examples one or more additional distance ranging sensors are located at the top of the tractor cab, at the rear of the cab, and/or at another location on the tractor facing the front of the conveyance, and with its viewing area/FoV including the front face of the trailer/conveyance. Data from this sensor can be used at least to initially estimate (initialize) the trailer/conveyance angle. In some examples the initialization of the trailer/conveyance angle is based on the kingpin position and a prior joint angle. The kingpin position can be determined algorithmically or set manually. For an estimate of the prior joint angle, a distance ranging sensor that has the front of the trailer in its viewing area can be used. In an example, front wall lidar points are used as data points to fit the initial joint angle of the trailer. In some examples, to estimate the entire state (e.g., size and joint angle) of the conveyance, data points from the LiDAR sensors are sorted into four classes, namely front wall, left wall, right wall, and other points. Using the prior front wall estimation, the data points are iteratively classified around the prior estimate into these classes by solving for a joint regression for the three walls.

In some examples another distance ranging sensor is located at the front of the tractor with its viewed area facing forward, and used at least for static and dynamic object detection. In some examples another distance ranging sensor is located at the rear bottom of the tractor, where it will end up underneath a towed trailer (or other towed conveyance) and can be used to help view blind-spots behind the conveyance, to assist with estimating the conveyance joint angle, for object detection, and for conveyance state estimation.

In an example, an optical imaging sensor (e.g., a camera) is packaged with each distance ranging sensor, and has a FoV that overlaps the viewed area of the ranging sensor it is packaged with. In an example the LiDAR viewing area encompasses all of the camera FOV. In some examples the camera data can be used for static and dynamic object detection and/or for lane detection. The use of image data for lane detection is disclosed in U.S. Patent Application Publication 2020/0327338 published on Oct. 15, 2020, the entire disclosure of which is incorporated by reference herein for all purposes.

The subject sensing system can be used to detect at least the left and right sides of: a trailer coupled to the tractor, a container carried by a chassis coupled to the tractor, and/or a chassis or other towed wheeled vehicle/conveyance coupled to the tractor. Although trailers, containers, and chassis have different shapes, they each have opposed left and right sides that can be detected by the distance ranging sensor(s), and/or imaging sensor(s), with the sensor data used to determine at least the angle relative to the tractor.

In some examples the sensing system also includes GPS sensing. In an example two GPS antennas are mounted to the top of the tractor, and spaced apart as far as possible. These two antennas can be used to determine the position and attitude of the tractor. In some examples a third GPS antenna is included in the sensor system, located in a fixed position externally of the tractor and serving as a reference point for the GPS system. The reference point can be used to calibrate the GPS system that uses the antennas carried by the tractor.

In some examples the imaging system is calibrated using a calibration sensor mounted to the fifth wheel of the tractor. For example, the calibration sensor can be mounted on a kingpin-like structure that is placed into the fifth wheel, which is the axis of rotation between the tractor and the connectable conveyance (e.g., a trailer or a chassis). The sensors carried by the tractor can be calibrated by obtaining spatial data of one or more objects displaced about the tractor with the calibration sensor and with the sensors mounted to the tractor and used in the active sensing system. These data can be processed to calibrate the sensors of the sensing system relative to the mounting location of the calibration sensor. Note that the calibration sensor can be mounted at any location of the tractor that is fixed and known relative to the active sensors carried by the tractor. Mounting to the fifth wheel is in some cases preferred because this location provides a mounting position that is rigid, measurable and transformable to a vehicle representation point that at least in some tractors is close to the center of gravity of the tractor. Representing a vehicle as the center of the rear-wheel axis is close to the vehicle center of gravity. Also this location is measurable compared to the true center of gravity. In some examples calibration accuracy requirements are high, requiring centimeter-level precision, thus having a point that is measurable is best. In some examples the location where the fifth wheel couples to the trailer kingpin is above the center of the real-wheel axis with a forward longitudinal shift of about 15.5 cm and vertical displacement of about 85 cm. These values are measurable and are near constant over most tractors, given manufacturing tolerances. If another location on the tractor is used for mounting of the calibration sensor, measurements from that location to the vehicle representation point could be made.

Due to manufacturing tolerances in both the original construction of the vehicle and in the addition of the subject sensor systems, the relative positions of the sensors (LIDARS, cameras, GPS antennas, etc.) to each other is either unknown or inaccurate. To best plot the motion of the vehicle relative to the environment that it is detecting and responding to, the relative position of the sensors must be accurately determined, especially in the case where two sensors see the same object but due to poor calibration will offer conflicting locations of it.

In some examples a solution to this problem is to temporarily install a new sensor (e.g., LIDAR, GPS, or camera) on the hitch (5^{th} wheel) of the tractor, which is the center of rotation for the trailer relative to the tractor. This location can serve as the origin axis of the vehicle and tractor in a simulated environment, and by having a sensor here and detecting various generic objects (walls, cones, cylinders, etc.) with it, the sensors can be calibrated around the vehicle to assume the same location of these generic objects. This in turn provides sensor-to-sensor calibration equal to the inherent accuracy of these systems, and prevents “seeing double” that might occur with a miscalibration.

Another means for sensor calibration of LIDARS to cameras is to use a large generic object (not shown) of known shape and size with a predetermined pattern (such as a ‘checkerboard’ pattern) on it, including 3D shapes of a known size. The LIDAR system will detect the overall shape and the shape of the cutouts or protrusions on it, and the cameras will use the checkerboard to correct for perspective warping that is inherent in camera systems. By referencing the image area of the cameras to the detected LiDAR point cloud of the shape, it is possible to gain an accurate calibration between the two systems to ensure that objects seen by one will register correctly with the other, or in the case of LIDAR/camera blind spots of one system, the other can be trusted completely without the need for verification of the other (color detection, false obstacles, etc.).

In some examples the left and right distance ranging sensors (e.g., LiDAR-based sensors) are each located outwardly of the respective side of the tractor. In an example their distance from the side of the tractor is such that the sensor is able to detect the entirety of the left or right side, respectively, of an attached trailer, chassis, container, or other wheeled conveyance that is coupled to the tractor's fifth wheel. In other words, the ranging sensor is able to detect the sidewall from its front edge to its rear edge. In some examples the ranging sensors are configured to accurately determine the location in space of the rear corners of the trailer, which also locates the hinge points of the rear trailer doors. To do so, there must be a sufficient amount of reliable data to provide accurate locations of these rear corners. Since the front of the trailer is also detected (e.g., by the distance ranging sensor mounted to the rear of the tractor), the sensing system is configured to locate the front, left, and right sides of the rectangular shape, thus locating the trailer in the 2D plane.

In use, the subject tractor and its structure being towed will be autonomously moved through locations that include obstacles, such as parked trailers, moving vehicles, fixed infrastructure, and the like. In some examples the left and right distance ranging sensors are mounted to the tractor such that they are below (i.e., closer to the ground than) the undersides of other tractors and trailers. In this case, as the tractor moves through the location, if the left or right sensor path intersects another trailer or tractor, it will pass below the vehicle and thus is more likely not to be damaged or destroyed. A particular non-limiting example is when the trailer is being parked next to one or two other trailers and the left and right sensors may need to pass underneath an adjacent trailer during the parking maneuver.

In one example the heights of the left and right sensors above the ground is established such that the sensors are able to image a two-foot high traffic cone from one meter away. This metric was selected based on assessing what the smallest, common, and dynamic obstacle in a yard would be, and in the case of the many yards this is a traffic cone. By making an accurate model of the cone, and of the tractor, various potential viewpoints around the vehicle can be simulated. Combined with returned data, a 3D shape can be simulated to show all possible locations where the sensor can perceive useful data. By moving the cone closer or further from the sensor, and changing the location of the sensor, the position can be tuned to image all small obstacles without sacrificing range of the sensor. In another example the heights of the left and right sensors is established such that they are able to image support posts that are sometimes located close to loading docks and meant to support the underside of a docked trailer; these support posts are commonly about 40 inches high.

In the examples in which the sensor system includes optical imaging sensors (such as cameras), the optical imaging sensors can be used for dynamic and static object detection, lane marking, safety identification, identification of other equipment, and the like. In order to facilitate the ability of a camera to capture desired images, the system can also include illumination source(s) to help illuminate the FoV of the camera(s). In one example lights are packaged together with each camera and oriented such that they illuminate some or all of the FoV of the camera. In some examples the cameras are used to identify structures that are within their FoV, a non-limiting example being the identity of other trailers in the location. For example, in a cargo yard there are typically many trailers parked at loading docks and in other parking spots. The cameras can be used to pick-up trailer identifying information (such as ID numbers located on a side of a trailer) as the tractor with the subject sensing system moves through the yard. In some examples the cameras are side-looking sensors (looking outward from the left and right sides of the tractor) and the lights illuminate their FoV. Such information can be reported back to a yard central control system, to help better manage the yard.

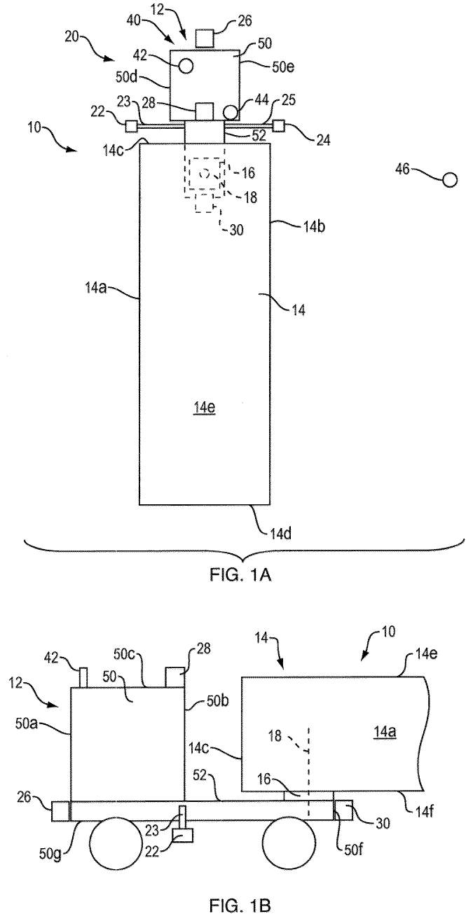

FIG. 1A is a top view of a tractor-trailer combination 10, and FIG. 1B is a side view thereof. Trailer 14 is coupled to tractor 12 via the fifth wheel coupling 16 of a type known in the field. Trailer 14 is able to rotate relative to tractor 12 about kingpin axis 18. Trailer 14 has front wall (side) 14c, left side wall 14a, right side wall 14b, rear wall (side) 14d, top 14e, and bottom 14f. Trailers are generally cuboid shaped, as are other structures that are conveyed by tractors, such as shipping containers (that are typically carried by a chassis that is coupled to the tractor). Tractor 12 comprises cab 50 and fifth wheel 16 both carried on wheeled chassis 52. Cab 50 has front wall 50a, rear wall 50b, top 50c, left sidewall 50d, right sidewall 50e, and bottom 50g.

Imaging system 20 is in part or in whole carried by tractor 12. Imaging system 20 includes distance ranging sensors, which are preferably but not necessarily LiDAR-based sensors of a type known in the field. Alternatives include but are not limited to radar-based sensors and ultrasonic-based sensors. In some examples imaging system 20 is configured to image at least one of a trailer or other conveyance that is connected to a tractor and an environment proximate the tractor. Imaging system 20 includes a plurality of sensors mounted to the tractor, wherein the sensors together have an active sensing area that encompasses at least the two opposed lateral sides of the trailer/conveyance. In the illustrated non-limiting example imaging system 20 includes sensors (or groups of sensors) 22, 24, 26, 28, and 30. In an example each of these sensors is a LiDAR sensor, a radar sensor and/or a camera. In another example one or more (or each) of these sensors is a group including a LiDAR sensor and a camera, generally configured to have the same viewed area/FoV or at least overlapping viewing areas/FoVs. Alternatively, cameras or other imaging sensors can be mounted separately from the distance ranging sensors. In some examples the system also includes one or more sources of visible light and oriented to light the field of view of one or more of the cameras. At least some of the cameras and their associated lights can be pointed outboard of the tractor-trailer (e.g., outwardly of the left and right sides and/or front and rear of the tractor) so that the system can image the surrounding environment and other vehicles, hazards, pavement/ground/environment markings and the like, all of which can be used to help autonomously navigate the tractor and the tractor-trailer/conveyance combination. In an example the camera(s) can be configured to be used for at least one of: static object detection, dynamic object detection, lane marking identification, safety identification, dock door identification, trailer identification, inspection for damage to the trailer, and robotic connection of the air hoses and electrical connections of the tractor to the trailer.

Imaging system 20 includes at least a left sensor 22 mounted to the left side 50d of the tractor and a right sensor 24 mounted to the right side 50e of the tractor. In an example the trailer has a width between the two opposed lateral sides 14a and 14b, and the left and right sensors are spaced apart by a distance that is greater than the width of the trailer. In some examples left sensor 22 is mounted such that it extends outwardly away from the left side 50d of the tractor and right sensor 24 is mounted such that it extends outwardly away from the right side 50e of the tractor. In an example the left and right sensors are spaced apart by at least eight feet, for example at least about 8.5 feet (e.g., more than 102 inches). In an example, imaging system 20 also includes one or more of front sensor 26 mounted to the front 50a of the tractor, rear sensor 30 mounted to the rear 50f of the tractor, and top sensor 28 mounted to the top 50c of the tractor. Top sensor 28 can be used to locate trailer front wall 14c. Rear sensor 30 can be used to image the underside 14f of the trailer, and also to image locations behind the trailer that might otherwise comprise blind spots that are not visible to other sensors mounted to the tractor. In an example rear sensor 30 is on the back of the tractor, farther to the rear of the tractor than the location where the kingpin couples to the tractor fifth wheel coupling. In an example where the tractor includes a “beaver tail” fifth wheel hitch that projects further behind the tractor and is lower than a typical fifth wheel hitch, the sensor can be mounted below the beaver tail or it could be mounted directly to the underside of the beaver tail. The sensor is thus farther behind the tractor and so may have an improved FoV. Also, the sensor located here is more protected from impact by the overlying beaver tail hitch. When the tractor/trailer is making a sharp turn this location at the back of the tractor will be exposed outside of the trailer, allowing the imaging of an otherwise blind location. Locating sensors here thus enhances the ability to visualize when making sharp turns, including when back up. A sensor (not shown) could also or alternatively be located on rear 50b of the cab to image the front 14c of the trailer.

Sensors 22 and 24 are preferably rigidly mounted to an unsprung portion of the tractor, for example to its chassis 52, rather than to the sprung cab 50. Such a rigid mounting helps the sensors to maintain a constant, known spatial relationship to the tractor (e.g., to the location of the fifth wheel that is used in sensor calibration as described elsewhere herein), thus assisting with using the distance ranging sensors to determine the position and attitude of the tractor and its trailer, as the tractor-trailer is moved through the yard. In an example the trailer bottom 14f has a height off the surface on which the wheels sit, and the left and right sensors are mounted below the bottom height of the trailer. This helps to prevent the sensors from hitting another similar trailer located close to the tractor, which can happen as the tractor-trailer is moved through the yard, and when a trailer is being dropped off or picked up and is close to one or more other trailers (e.g., trailers parked in rows in a holding lot or at loading docks).

In some examples the system further comprises a global positioning system (GPS) 40 carried at least in part by the tractor. In an example the GPS comprises two GPS antennas 42 and 44 mounted to the roof/top 50c of the tractor, such that a position and attitude of the tractor can be determined using the two GPS antennas without the need for the tractor to be in motion. In an example the GPS 40 comprises a third antenna 46 located externally of the tractor in a fixed, non-moving location and serving as a reference point for the GPS.

In some examples the length of the trailer/conveyance is estimated based on data from at least the left and right distance ranging sensors. Estimation of the location of the rear end of the trailer/conveyance is an aspect of length estimation. Accuracy of the rear end estimation is useful when backing a trailer to a dock door; over-estimating its length can lead to a gap between the trailer and the loading dock that the forklifts used to load the trailer may not be able to cross, while underestimation can lead to a collision with the dock door, potentially damaging the trailer or the dock. When LiDAR-based sensors are used for the ranging sensors, they may have a fixed horizontal angular resolution. Depending on their mounting distance from the vehicle body, the intersection point of their rays with the trailer will change. When they are mounted very close to the vehicle body there can be a large distance along the length of the trailer between the intersection points of sequential LiDAR rays and the trailer as compared to when they are mounted farther out; the gap between rays will be reduced as a function of how far outwardly of the vehicle the sensors are mounted. To reliably determine the rear end of the trailer, this gap should be relatively small, thus leading to an optimal mounting location outboard of the vehicle body. While higher angular resolution sensors are available and can help to alleviate this issue, they would be applying that higher resolution to the entire imaging sweep, vastly increasing the amount of data generated and also vastly increasing the computational requirements of the image processing systems. An upgrade in the sensors would necessitate an upgrade in computation. Accordingly, mounting lower resolution sensors farther from the sides of the conveyance is a practical solution. Also, the amount of light reflected from a side of the conveyance (and thus the number of returned data points) is related to the angle of incidence of the light rays with the surface. A greater angle is thus advantageous. A limitation to moving the sensors far outside the tractor or trailer width is that they become more prone to collisions with other objects in the yard, which restricts maneuverability of the tractor.

There are several considerations relating to locating the left and right distance ranging sensors in a cartesian plane relative to the trailer/conveyance. Some of these considerations relate to optimizing sensor performance and behavior, and others relate to mechanical limitations having an effect on their locations. For instance, locating the sensors in the longitudinal axis (the forward/aft axis) is a factor of the turning circle of the truck and avoiding extending the effective area of it. With sensors placed in the front corners of the tractor, it would greatly increase the chance of impact of them in the environment, especially in the tight quarters of a freight yard in which the area required to pull out and turn a trailer is frequently smaller than the trailer and tractor combination. Moving the sensors further back reduces this risk. Another consideration is optimizing the area of the trailer that can be visualized by these sensors. Placing the sensors right behind the cab keeps the sensors far enough away from the trailer such that they can visualize most or all of the left and right sides of the trailer, but without the mechanical limitations of interfering with operator access to the vehicle or risking collision with the landing gear of trailers during extreme (90 degree) turns. In some tractor examples the left and right sensors are mounted to the tractor chassis about 10 cm behind the rear cabin and exhaust system, but forward of the side staircases by about 5 cm. This is about 60 cm behind the front axle and about 230 cm in front of the rear axle.

Latitudinal location (i.e. the distances of the sensors from the cab, or from the centerline of the tractor) is a more complex problem. In a yard environment the sensor system needs to sense structures such as dock doors and walls behind the trailer. This information is important for accurate parking of a trailer the correct distance from a dock door longitudinally. However, due to the inconsistent nature of the landing gear, wheels, axles and air tanks under various trailer styles, this information can only be gathered from outside of (i.e., to the left and right of) the trailer's area. It is therefore necessary to extend the sensors outside of the pertinent legal width of the trailer, which in the U.S. is 102″. For off-road only vehicles (for use on private property), the left and right sensors can be spaced apart by more than this 102″ limit.

Also, there are reasons to extend the left and right sensors further beyond just the 102″ required to see docks and obstacles behind the trailer. For instance, the left and right distance ranging sensors can be used to detect the trailer attitude and position relative to the tractor, which can be important in precision jobs like parking. By detecting either side of the trailer as well as the rear corners, an estimated model for its position and attitude can be determined. The more of a trailer's sides that can be seen, the higher the accuracy of this measurement. The further out the left and right sensors are, the more of the sides can be seen.

In some examples LiDAR sensors have a generally conical viewing area of about 30 degrees. If such sensors are located 2″ outside of the 102″ trailer width (i.e., 106 inches apart) there is about a 4.6 degree angle between the sensor and the closest front corner of the trailer, meaning that the trailer side encompasses only about 4.6 degrees of the sensor viewing area, which will return relatively few data points from the side, making sensing of the entire side and its rear corner difficult. If the sensors are moved out to 10″ outside of the trailer width this angle increases to about 21.6 degrees. In some examples the lateral distance between the left and right sensors is selected such that for the particular LiDAR sensors used, the trailer side encompasses enough of the sensor viewing area such that the sensor is likely to return enough data to reliably sense the sidewall. In some examples the LiDAR sensors and their lateral locations are selected such that a resolution on the determination of the trailer length, and the maximum allowable spacing of the data points returned from the sides of the trailer, is in the range of from about 1 cm to about 50 cm, with a preferred resolution of no more than about 10 cm. This resolution will allow the system to reliably determine the sidewall location. In some examples the left and right sensors are located about 145 cm from the vehicle centerline, and potentially up to about 155 cm, which equates to a distance between sensors of about 114 inches.

A drawback to having sensors excessively outside of the width of the tractor and trailer is that it increases the risk of collision of a sensor with other vehicles and trailers in the yard, and can make parking a much more difficult task. Therefore, it is advantageous to place the sensor as close to the tractor as possible while still perceiving the minimum amount of trailer side necessary for functionality. The more of the sides that are detected by the left and right sensors, the more accurate a picture of them can be obtained. In one example using LiDAR sensors the lateral placement is such that the angle to the front corners of the sides is at least 0.3 degrees in order to accurately characterize the position of the trailer. In one example left and right LiDAR sensors are displaced laterally away from tractor a sufficient distance such that the portion of the sensor FoV filled by the truck side wall is at least about 0.3 degrees, when the tractor and trailer are misaligned by up to about +/−3.0 degrees.

Another factor that can have an effect on lateral sensor placement is that when a tractor backs into and couples with a trailer, often the tractor is left at some angle relative to the trailer. This angular misalignment can partially or fully occlude one of the two sensors. However, the effect of the angle on the sensor viewing area is quantifiable, allowing the sensors to be placed at least far enough apart such that they can visualize the minimum of the trailer sides at peak misalignment. In an example this angular misalignment is +/−3 degrees and the sensor locations are set accordingly. Preferably, the sensors are spaced wide enough to obtain sufficient data along the entire side of the trailer when misalignment is 3 degrees.

Having sensors outside of the maximum trailer width does present another mechanical limitation, especially in cases of mixed trailer length yards. In some examples it is common to park a 53′ long trailer next to a 40′ long trailer, biasing their rear doors against the wall or loading dock door. In yards with particularly close trailer parking, this can lead to any sensors outside of the 102″ legal limit striking a trailer next to it during parking.

To avoid collision in these circumstances, it is necessary to have the sensor location either above or below the trailer. Most trailers are resting on “legs” or “landing gear” that keep them 40-50″ above the ground, allowing tractors (and their fifth wheels) to slide underneath them. This feature can be used for the left and right ranging sensors as well, placing them under the 40″ minimum height commonly seen in trailers. That way, when a close parking incident does occur, the sensor can slide under the neighboring trailer without threat of hitting.

Similar to other sensor positions, there is a tradeoff for the quality of the data and a desire to place the sensor in an optimal position. Vertical placement affects sensor data in at least three different ways: self-occlusion, multi-object occlusion, and ground plane data falloff. Self-occlusion refers to the ability of the vehicle in question to hide in the blind-spot of the sensor and increase the seen area around it. Due to the preferred horizontal mounting locations (greater than 102″ distance between the left and right sensors), self-occlusion is likely not a problem. Multi-object occlusion refers to the ability of sensors to see behind objects shorter than the vertical mounting position, with higher viewpoints being more effective at seeing through crowds of objects. Ground plane data falloff refers to the percentage of data detected by a sensor with a limited vertical field of view being used to sense useful objects in the distance versus detecting the ground

Considering a LiDAR sensor with a 30 degree field of view, at a distance of 20 feet from the sensor it is extremely sensitive on what percentage of the data is detecting useful objects versus detecting the plane of the ground, based on the height at which the sensor is mounted. At a mounting height of 80″, the ground plane is not detected. At a mounting height of 10″, over a third of the returned data will be from the ground. At 40″ less than 20% of the returned data will be from the ground. Therefore, it is beneficial to mount the sensor as high as possible (e.g., at or just under 40″ from the ground) without encountering the mechanical limitation of striking the underside of another trailer.

Table 1 (below) identifies the ranging and imaging sensors of a preferred embodiment of the system, considerations regarding sensors, and uses of the sensors.

FIG. 1C schematically depicts tractor chassis 61 that defines front area 62 where the cab (not shown) would typically be located, and rear area 63 where the fifth wheel (not shown) would typically be located. Other features of the chassis are not shown for the sake of clarity of illustration. The figure illustrates cab-protective frame 64 that is rigidly mounted to chassis 61 and, as described above, can carry sensors (not shown). Sensor package 65 is depicted coupled to the back of the chassis and includes LiDAR sensor 66 that is coupled to the chassis by passive or active vibration isolation mount 67. The same arrangement can be used to mount sensors such as the left and right side LiDAR sensors to frame 64. Also, sensors can be rigidly mounted to the chassis (or protection frame/rails including the top rail for top sensors), or the sensors can be mounted via suspensions (passive or active).

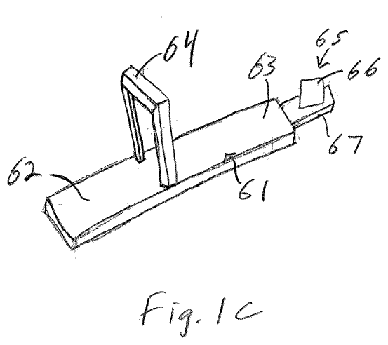

FIG. 2 is a schematic block diagram of a tractor-trailer/conveyance imaging and navigation system 80. Processor 88 is configured to process data from the plurality of sensors (e.g., one or more of LiDAR sensor set 82, camera sensor set 84, and GPS sensor set 86) to develop position data for the trailer/conveyance that can comprise part of its outputs 90, and can be developed from further processing of the output data.

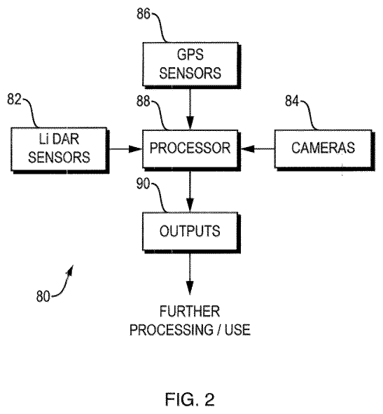

FIG. 3 is a model 102 of a tractor 104-trailer 106 combination useful in understanding aspects of the present disclosure. Tractor 104 is pointed along axis 105 that lies at an angle Θ_{H} to horizontal axis 110, which is parallel to arbitrary horizontal axis 108. Trailer 106, which is configured to pivot relative to tractor 104 about vertical kingpin axis 112, lies at an angle Θ_{T} to axis 108. Trailer 106 includes rear doors 113 and 115 which are depicted as open rather than closed. The joint angle δ is the angle between the tractor and its trailer and equals Θ_{T}−Θ_{H}. Dimension d is the length of the trailer from its kingpin to its rear wheels. As the tractor-trailer moves, the joint angle can be computed from the prior joint angle and the change in the tractor heading over the time since the prior joint angle was determined.

When the distance ranging sensors are LiDAR sensors, each sensor typically periodically returns a set of data comprising the received reflectances. The data received from all of the LiDAR sensors can be synchronized, or not. The entire data set may be referred to as a point cloud. In some examples, by fitting a rectangle of the approximate size of the trailer (which can be initially determined by the left, right, and rear LiDAR sensors or in another way such as by measurement or manufacturer data) to the point cloud, the angle of the trailer relative to the tractor can be determined. Since the location and attitude of the tractor is known via the GPS system, and since the size of the trailer is known, knowing the joint angle fully defines the present location and attitude of the trailer. This information can be used by a navigation system (not shown) to autonomously navigate the tractor/trailer.

In another example a rectangle is fit to a subset of the point cloud data rather than to all of the point cloud data. Also, there may or may not be information available about the trailer dimensions. It could be that the trailer is identified to the system and the system stores dimensional information about the trailer in a database. However, the autonomous vehicle may also not know anything about the trailer when it first encounters it, and may only learn what it can sense from measurements (as opposed to looking up data in a table).

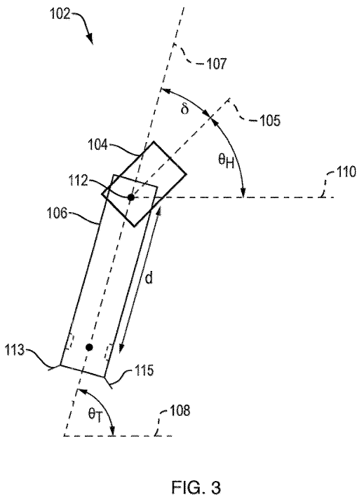

In some examples the system processor is configured to fit a predetermined shape representing the trailer (e.g., three contiguous sides of a rectangle) to the trailer position data as determined by the distance ranging sensors. In an example the position data for the trailer comprises at least one of a trailer length, a trailer width, a trailer height, a location of a rear axle of the trailer, a location of a kingpin, and an angle between the tractor and the trailer. FIG. 4 is a flowchart of a trailer state (i.e., joint angle) estimation method 120. Brute force rectangle fitting determines an approximate joint angle by fitting a rectangle of the size of the trailer to the point cloud. In an example this is accomplished by counting the number of point cloud data points that lie within the neighborhood of the three sides of the rectangle. Through this process the best rectangle (i.e., the best joint angle fit) is determined. An updated trailer state is determined based on this joint angle, the prior updated trailer state, and inputs from GPS and any other motion sensors (i.e., speed and heading). A least square fit to a synchronized point cloud around the last iteration of the fitted rectangle is iterated until it converges. The trailer state is updated using this fitted rectangle. The rectangle fitting on the synchronized point cloud can provide a frame-by-frame trailer state estimation.

In some examples the left side and right side distance ranging sensors can be used to detect if the trailer rear doors are open, such as depicted in FIG. 3. The distance ranging sensors (e.g., LiDAR sensors) can look at the rear corners of the trailer. The hinge points of each of the two rear trailer doors is known, and it is also known that trailer doors should be about one-half the width of the trailer, where trailer width will be known from measurement of trailer side locations by the lidars sensors already. The system can look to see if an object is located in the vicinity of the hinge point with a width dimension approximating one-half the trailer width. A use case is that when a trailer is pulled away from dock doors by the tractor, currently the tractor is supposed to stop once the trailer is pulled out far enough to allow the doors to be closed and latched. If the doors are not latched they can swing around when the trailer starts being moved again. The system can sense the swinging doors and send an exception halt to the autonomous system so that someone can secure the doors. This avoids damaging the doors (e.g., keeping them from hitting nearby trailers).

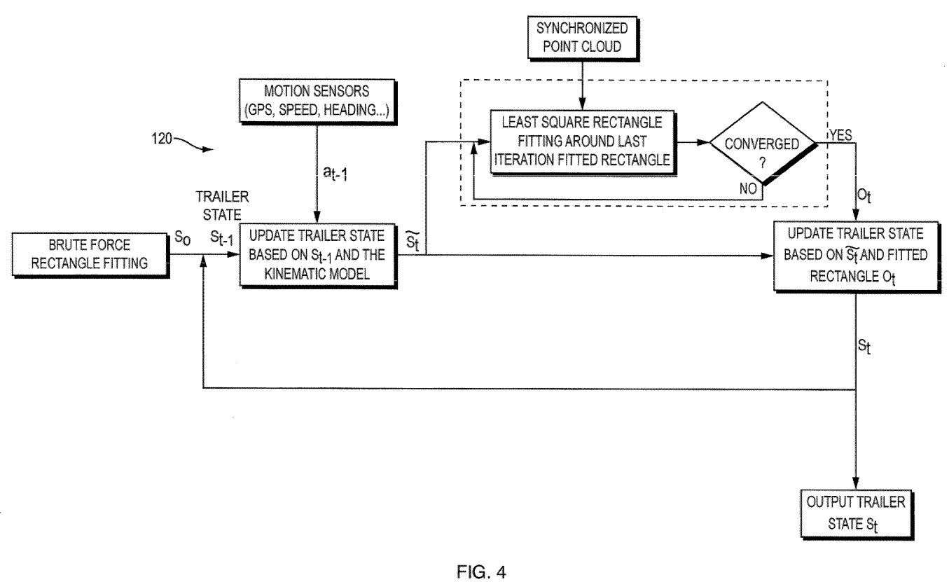

FIG. 5 is a top view of tractor 12 maneuvering to pick up a parked trailer 204 that has front wall 204a, right side 204b, and left side 204c. Distance ranging sensors can be used in this scenario. A desire is to reduce the uncertainty of estimating the target trailer. For this at least one side of the trailer is used for the estimation. One or more other sides can be used based on the estimation confidence and uncertainty using one side. First, the tractor is stopped in front of the target trailer and the target trailer pose is estimated using the front wall 204a (in this case using one or both of distance ranging sensors 24 and 26). If the front wall estimation is not of high confidence and low uncertainty, the tractor is moved so as to observe an additional side (204b or 204c), typically the left or right, using any sensor(s), such as one or more of sensors 22, 24, and 26, and re-estimate the target trailer position using the same. If there still is not a high confidence and low uncertainty, the tractor is moved again so as to observe the other of the left and right sidewalls and another estimation is performed, to converge to the best estimation of the trailer location and angle. In some examples the tractor then proceeds to align itself with the target trailer before proceeding to couple to the target trailer for transport thereof.

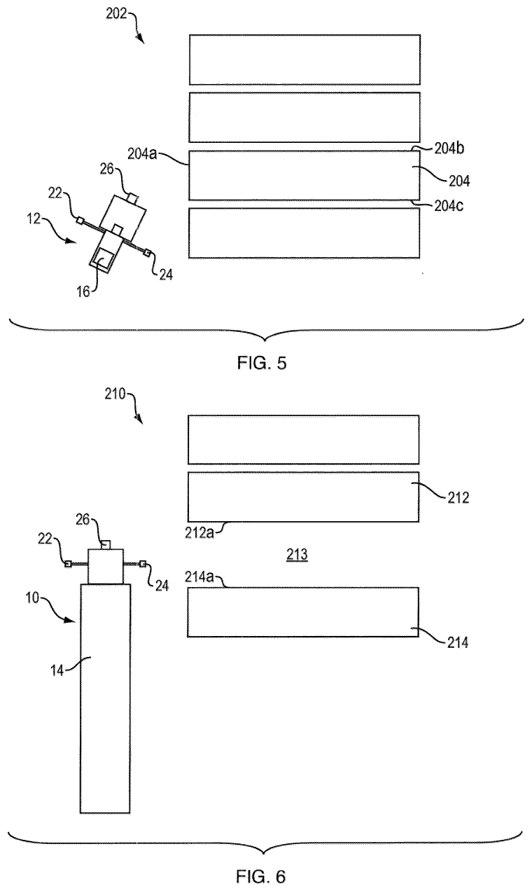

FIG. 6 is a top view of a tractor-trailer 10 maneuvering to drop off the trailer 14 in empty parking space 213 located between parked trailer 212 with side 212a facing space 213 and parked trailer 214 with side 214a facing space 213. Note that there could be two, one, or no trailers adjacent to parking space 213. A desire is to reduce the uncertainty in the designated parking area and its vicinity with no blind spots. The first step is to check if there are trailers in adjacent parking spots. If there is a trailer in the right parking spot (trailer 212), the system estimates the location of its left wall surface 212a. If there is a trailer in the left parking spot (trailer 214), the system estimates its right wall surface 214a. If there are no trailers then the wall is represented by the parking spot boundary (e.g., painted lane markings imaged by the camera). In the area of interest, between walls 212a and 214a, every point that represents a unit space in the area of interest is marked as occupied or unoccupied in order to ensure there is no blind-spot. Once the status of every point is determined, parking path planning can be enabled and parking initiated.

In another aspect a method for calibrating sensors for a system for spatially imaging at least one of a trailer that is connectable to a tractor when the trailer is connected to the tractor and an environment proximate the tractor includes identifying an axis of rotation between the tractor and the connectable trailer when the trailer is connected to the tractor. A calibration sensor (e.g., a LiDAR sensor) is mounted to the tractor when the connectable trailer is not connected to the tractor, at the kingpin axis 18, FIG. 1. This sensor is then used to obtain spatial data of fixed objects displaced about the tractor. At the same time, the other distance ranging sensors of the tractor's sensing system are used to obtain spatial data of these same objects. The collected spatial data is then processed, to calibrate the one or more sensors of the spatial imaging system relative to the mounting location of the calibration sensor (i.e., the kingpin location). Once calibrated, and until they are moved or otherwise altered, the system sensors can be used to accurately determine the joint angle.

TABLE 1

| | | Location | | |
|---|---|---|---|---|
| Sensor | Sensor | on | | Primary Purpose (bold)/ |
| Category | Name | Tractor | x/y Considerations | Other uses |
| LiDAR | MR | Middle | Should go under | Static and dynamic object |
| | | Right | trailers | detection |
| | | | Should detect 2 ft | Joint angle estimation |
| | | | cones 1 m away | Lidar Mapping and |
| | | | Should observe ego | Localization |
| | | | trailer side i.e. must be | |
| | | | wider than trailer width | |
| LiDAR | ML | Middle | Should go under | Static and dynamic object |
| | | Left | trailers | detection* |
| | | | Should detect 2 ft | Joint angle estimation |
| | | | cones 1 m away | Lidar Mapping and |
| | | | Should observe ego | Localization |
| | | | trailer side i.e. must be | |
| | | | wider than trailer width | |
| LiDAR | FC | Front | Best mounting | Static and dynamic object |
| | | Center | available | detection* |
| | | | | Lidar Mapping and |
| | | | | Localization |
| LiDAR | RC | Rear/Top | Centered to truck | Joint Angle Initialization |
| | | Center | Trailer front wall | Target trailer state estimation |
| | | | width visible in entirety | |
| LiDAR | RBC | Rear | Under the ego trailer | Blindspot coverage |
| | | bottom | View of blind spots | Joint Angle estimation |
| | | center | behind ego | Object detection |
| | | | | Target trailer state estimation |
| Camera | Cam | Packaged | Centered to truck | Static and dynamic object |
| | FC | with | Cameras cover little >180 | detection |
| | | Lidar | deg coverage | Lane marking and safety |
| | | Front | overlapping with lidar | identification |
| | | Center | Field of View (FoV) | |
| | | | All cameras are tightly | |
| | | | packaged to minimize | |
| | | | cable distribution and | |
| | | | streamline assembly to | |
| | | | vehicle | |
| | | | Individual pitch | |
| | | | adjustment on each | |
| | | | camera for tuning to | |
| | | | specific application, set | |
| | | | Yaw angle | |
| Camera | Cam | Packaged | Desire to use identical | Static and dynamic object |
| | MR | with | hardware to FC | detection |
| | | Lidar | Tradeoff between | Dock Door identification |
| | | Middle | seeing the trailer and | |
| | | Right | blind-spot off the front | |
| | | | right corner of the truck | |
| Camera | Cam | Packaged | Desire to use identical | Static and dynamic object |
| | ML | with | hardware to FC | detection |
| | | Lidar | Tradeoff between | Dock Door identification |
| | | Middle | seeing the trailer and | |
| | | Left | blind-spot off the front | |
| | | | left corner of the truck | |
| Camera | Cam | Packaged | High location | Confirmation of Target |
| | RC | with | Well lit | Trailer ID |
| | | Lidar | FOV centered on | Inspection for Damage |
| | | Rear- | trailer front face | Assisting in auto-coupling |
| | | facing top | | |
| | | center | | |
| Camera | Cam | Camera | Higher location on | Trailer Number |
| | ML | unit with | cabin sides | Identification |
| | High | high | | |
| | | resolution | | |
| | | and FoV | | |
| | | observing | | |
| | | ego sides | | |
| Camera | Cam | Camera | Higher location on | Trailer Number |
| | MR | unit with | cabin sides | Identification |
| | High | high | | |
| | | resolution | | |
| | | and FoV | | |
| | | observing | | |
| | | ego sides | | |

Elements of figures are shown and described as discrete elements in a block diagram. These may be implemented as one or more of analog circuitry or digital circuitry. Alternatively, or additionally, they may be implemented with one or more microprocessors executing software instructions. The software instructions can include digital signal processing instructions. Operations may be performed by analog circuitry or by a microprocessor executing software that performs the equivalent of the analog operation. Signal lines may be implemented as discrete analog or digital signal lines, as a discrete digital signal line with appropriate signal processing that is able to process separate signals, and/or as elements of a wireless communication system.

When processes are represented or implied in the block diagram or the flow chart, the steps may be performed by one element or a plurality of elements. The steps may be performed together or at different times. The elements that perform the activities may be physically the same or proximate one another, or may be physically separate. One element may perform the actions of more than one block.

Examples of the systems and methods described herein comprise computer components and computer-implemented steps that will be apparent to those skilled in the art. For example, it should be understood by one of skill in the art that the computer-implemented steps may be stored as computer-executable instructions on a computer-readable medium such as, for example, floppy disks, hard disks, optical disks, Flash ROMS, nonvolatile ROM, and RAM. Furthermore, it should be understood by one of skill in the art that the computer-executable instructions may be executed on a variety of processors such as, for example, microprocessors, digital signal processors, gate arrays, etc. For ease of exposition, not every step or element of the systems and methods described above is described herein as part of a computer system, but those skilled in the art will recognize that each step or element may have a corresponding computer system or software component. Such computer system and/or software components are therefore enabled by describing their corresponding steps or elements (that is, their functionality), and are within the scope of the disclosure.

A number of implementations have been described. Nevertheless, it will be understood that additional modifications may be made without departing from the scope of the inventive concepts described herein, and, accordingly, other examples are within the scope of the following claims.

1. A system for imaging at least one of a trailer or other conveyance that is connected to a tractor and an environment proximate the tractor, wherein the trailer or other conveyance has two opposed lateral sides, the system comprising:
a plurality of sensors mounted to the tractor, wherein the sensors together have an active sensing area that encompasses at least the two opposed lateral sides of the trailer or other conveyance,
wherein the tractor has a left side and a right side, and the plurality of sensors comprises a left sensor mounted such that it extends outwardly away from the left side of the tractor and a right sensor mounted such that it extends outwardly away from the right side of the tractor.

2-3. (canceled)

4. The system of claim 1, wherein the left and right sensors are spaced apart by at least 102 inches.

5. The system of claim 4, wherein the tractor has a front, a rear, and a top, and wherein the plurality of sensors further comprises at least one of a front sensor mounted to the front of the tractor, a rear sensor mounted to the rear of the tractor, and a top sensor mounted to the top of the tractor.

6. The system of claim 1 wherein the left and right sensors are distance ranging sensors, wherein the distance ranging sensors comprise at least one of a LIDAR-based sensor, a radar based sensor, and an ultrasonic based sensor.

7. The system of claim 6, wherein the left and right distance ranging sensors are spaced apart laterally such that a resolution on a determination of a length of the trailer or other conveyance, and a maximum allowable spacing of the data points returned from left and right sides of the trailer or other conveyance, is in the range of from about 1 cm to about 50 cm.

8. The system of claim 1, wherein the trailer or other conveyance has a bottom height, and wherein the left and right sensors are mounted below the bottom height of the trailer or other conveyance.

9. The system of claim 1, wherein the left and right sensors are spaced apart sufficiently such that they can obtain position data along the entire side of the trailer or other conveyance when misalignment between the tractor and the trailer or other conveyance is up to about 3 degrees.

10. The system of claim 1, wherein the left and right sensors are displaced laterally away from the tractor a sufficient distance such that the portion of the sensor field of view filled by the trailer or other conveyance side wall is at least about 0.3 degrees, when the tractor and the trailer or other conveyance are misaligned by up to about +/−3.0 degrees.

11-12. (canceled)

13. The system of claim 1, further comprising a processor that is configured to process data from the plurality of sensors to develop position data for the trailer or other conveyance.

14. The system of claim 13, wherein the processor is further configured to fit a predetermined shape representing the trailer or other conveyance to the position data.

15. The system of claim 13, wherein the position data for the trailer or other conveyance comprises at least one of a trailer or other conveyance length, a trailer or other conveyance width, a trailer or other conveyance height, a location of a rear axle of the trailer or other conveyance, a location of a kingpin, and an angle between the tractor and the trailer or other conveyance.

16. The system of claim 1, wherein the plurality of sensors comprise at least one of a front camera mounted to the front of the tractor, a rear camera mounted to the rear of the tractor, a right side camera mounted to the right side of the tractor, a left side camera mounted to the left side of the tractor, and a top camera mounted to the top of the tractor.

17. The system of claim 16, wherein at least one camera is oriented with a field of view proximate a side of the tractor, the system further comprising an illumination system configured to provide light to the at least one camera field of view.

18. The system of claim 16, wherein the trailer or other conveyance has a front side, and wherein a camera is oriented with a field of view that includes the front side of the trailer or other conveyance.

19. The system of claim 16, wherein the at least one camera is configured to be used for at least one of: static object detection, dynamic object detection, lane marking, safety identification, dock door identification, trailer or other conveyance identification, inspection for damage to the trailer or other conveyance, and robotic connection of air hoses and electrical connections of the tractor to the trailer or other conveyance.

20. The system of claim 1, further comprising a global positioning system (GPS) carried at least in part by the tractor.

21. The system of claim 20, wherein the GPS comprises two GPS antennas mounted to a roof of the tractor, such that a position and attitude of the tractor can be determined using the two GPS antennas without the need for the tractor to be in motion.

22. The system of claim 21, wherein the GPS comprises a third antenna located externally of the tractor in a fixed, non-moving location and serving as a reference point for the GPS.

23. The system of claim 1, wherein the sensors are used to image at least one open rear door of a trailer or other conveyance that is connected to the tractor.

24. A method for calibrating sensors for a system for spatially imaging at least one of a trailer or other conveyance that is connectable to a tractor when the trailer or other conveyance is connected to the tractor and an environment proximate the tractor, the method comprising:
identifying an axis of rotation between the tractor and the connectable trailer or other conveyance when the trailer is connected to the tractor,
mounting a calibration sensor to the tractor when the connectable trailer or other conveyance is not connected to the tractor at an intersection point between the axis of rotation and the tractor,
obtaining spatial data of objects displaced about the tractor with the calibration sensor and with one or more sensors of the spatial imaging system that are mounted to the tractor; and
processing the spatial data to calibrate the one or more sensors of the spatial imaging system relative to the mounting location of the calibration sensor.

25. The system of claim 1 wherein the tractor comprises a chassis and a cab which is mounted to the chassis, wherein the left and right sensors are mounted to the chassis.

26. The system of claim 25 wherein the left and right sensors are mounted to the chassis using vibration isolation mounts.

27. The system of claim 1 wherein the tractor comprises a beaver tail fifth wheel, wherein at least one sensor of the plurality of sensors is mounted to an underside of the beaver tail.

28. The system of claim 13 wherein the processor, responsive to the position data, calculates a joint angle between the tractor and the trailer.
